(19) United States
(12) Patent Application Publication
(10) Pub. No.: US 2025/0056519 A1
(43) Pub. Date: Feb. 13, 2025

(54) MECHANISM FOR REINFORCEMENT LEARNING ON BEAM MANAGEMENT

(71) Applicant: Nokia Technologies Oy, Espoo (FI)

(72) Inventors: Ahmad MASRI, Tampere (FI); Afef FEKI, Sceaux (FR); Jian SONG, Palaiseau (FR); Vismika Maduka RANASINGHE MUDIYANSELAGE, Oulu (FI)

(21) Appl. No.: 18/794,110

(22) Filed: Aug. 5, 2024

Related U.S. Application Data
(60) Provisional application No. 63/518,236, filed on Aug. 8, 2023.

(51) Int. Cl. H04W 72/044; H04W 72/40; H04W 72/54; H04W 92/18

(52) U.S. Cl. CPC H04W 72/046; H04W 72/40; H04W 72/54; H04W 92/18

(57) ABSTRACT

The present disclosure relates to a reinforcement learning (RL) on beam management. In particular, it utilizes side links capabilities for enabling real data/traffic exchange for RL explorative training step. In this way, it enables a radio system performance friendly RL learning training operation from one side and will utilize the available radio air resources on the other side.

### FIELDS

Various example embodiments of the present disclosure generally relate to the field of telecommunication and in particular, to methods, devices, apparatuses and computer readable storage medium for reinforcement learning on beam management.

### BACKGROUND

There are multiple examples of Machine Learning (ML) algorithms for a wireless communication network (e.g., a Next-Generation Radio Access Network (NG-RAN)) which offer various Radio Resource Management (RRM) improvements. Machine learning, such as reinforcement learning or deep reinforcement learning may be used as a decision-making tool to address complex problems which are highly dimensional given the number of control parameters to be optimized and stringent timing constraints. Therefore, it is worth to further study AI/ML techniques.

### SUMMARY

In a first aspect of the present disclosure, there is provided an apparatus. The apparatus comprises at least one processor; and at least one memory storing instructions that, when executed by the at least one processor, cause the apparatus to: receive, from a network device, a continual learning configuration indicating at least one of: a neighbor apparatus, a first identity of a first beam, or a second identity of a second beam; transmit, to the neighbor apparatus, a sidelink message comprising data and the second identity of the second beam; and transmit, to the network device, the data via the first beam.

In a second aspect of the present disclosure, there is provided an apparatus. The apparatus comprises at least one processor; and at least one memory storing instructions that, when executed by the at least one processor, cause the apparatus to: receive, from a network device, a continual learning configuration indicating at least one of: the apparatus, a first identity of a first beam, or a second identity of a second beam; receive, from a neighbor apparatus, a sidelink message comprising data and the second identity of the second beam; and transmit, to the network device, the data via the second beam.

In a third aspect of the present disclosure, there is provided an apparatus. The apparatus comprises at least one processor; and at least one memory storing instructions that, when executed by the at least one processor, cause the apparatus to: transmit, to a first terminal device, a continual learning configuration indicating at least one of a second terminal device, a first identity of a first beam, or a second identity of a second beam; transmit the continual learning configuration to at least one second terminal device; receive, from the first terminal device, data via the first beam; and receive, from the second terminal device, the data via the second beam.

In a fourth aspect of the present disclosure, there is provided a method. The method comprises: receiving, from a network device, a continual learning configuration indicating at least one of: a neighbor apparatus, a first identity of a first beam, or a second identity of a second beam; transmitting, to the neighbor apparatus, a sidelink message comprising data and the second identity of the second beam; and transmitting, to the network device, the data via the first beam.

In a fifth aspect of the present disclosure, there is provided a method. The method comprises: receiving, from a network device, a continual learning configuration indicating at least one of: the apparatus, a first identity of a first beam, or a second identity of a second beam; receiving, from a neighbor apparatus, a sidelink message comprising data and the second identity of the second beam; and transmitting, to the network device, the data via the second beam.

In a sixth aspect of the present disclosure, there is provided a method. The method comprises: transmitting, to a first terminal device, a continual learning configuration indicating at least one of a second terminal device, a first identity of a first beam, or a second identity of a second beam; transmitting the continual learning configuration to a second terminal device; receiving, from the first terminal device, data via the first beam; and receiving, from the second terminal device, the data via the second beam.

In a seventh aspect of the present disclosure, there is provided a first apparatus. The first apparatus comprises means for receiving, from a network device, a continual learning configuration indicating at least one of: a neighbor apparatus, a first identity of a first beam, or a second identity of a second beam; means for transmitting, to the neighbor apparatus, a sidelink message comprising data and the second identity of the second beam; and means for transmitting, to the network device, the data via the first beam.

In an eighth aspect of the present disclosure, there is provided a second apparatus. The second apparatus comprises means for receiving, from a network device, a continual learning configuration indicating at least one of: the apparatus, a first identity of a first beam, or a second identity of a second beam; means for receiving, from a neighbor apparatus, a sidelink message comprising data and the second identity of the second beam; and means for transmitting, to the network device, the data via the second beam.

In a ninth aspect of the present disclosure, there is provided a third apparatus. The third apparatus comprises means for transmitting, to a first terminal device, a continual learning configuration indicating at least one of a second terminal device, a first identity of a first beam, or a second identity of a second beam; means for transmitting the continual learning configuration to a second terminal device; means for receiving, from the first terminal device, data via the first beam; and means for receiving, from the second terminal device, the data via the second beam.

In a tenth aspect of the present disclosure, there is provided a computer readable medium. The computer readable medium comprises instructions stored thereon for causing an apparatus to perform at least the method according to the fourth aspect.

In an eleventh aspect of the present disclosure, there is provided a computer readable medium. The computer readable medium comprises instructions stored thereon for causing an apparatus to perform at least the method according to the fifth aspect.

In a twelfth aspect of the present disclosure, there is provided a computer readable medium. The computer readable medium comprises instructions stored thereon for causing an apparatus to perform at least the method according to the sixth aspect.

It is to be understood that the Summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example communication environment in which example embodiments of the present disclosure can be implemented;

FIG. 2 illustrates a schematic diagram of agent-environment interaction for reinforcement learning;

FIG. 3 illustrates a signaling chart for a lightweight test mode for reinforcement learning according to example embodiments of the present disclosure;

FIG. 4 illustrates a schematic diagram of updating a model according to example embodiments of the present disclosure;

FIG. 5 illustrates a flowchart of a method implemented at a first device according to some example embodiments of the present disclosure;

FIG. 6 illustrates a flowchart of a method implemented at a second device according to some example embodiments of the present disclosure;

FIG. 7 illustrates a flowchart of a method implemented at a third device according to some example embodiments of the present disclosure;

FIG. 8 illustrates a simplified block diagram of a device that is suitable for implementing example embodiments of the present disclosure; and

FIG. 9 illustrates a block diagram of an example computer readable medium in accordance with some example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first,” “second,” . . . , etc. in front of noun(s) and the like may be used herein to describe various elements, these elements should not be limited by these terms. These terms are only used to distinguish one element from another and they do not limit the order of the noun(s). For example, a first element could be termed a second element, and similarly, a second element could be termed a first clement, without departing from the scope of example embodiments. As used herein, the term “and/or” includes any and all combinations of one or more of the listed terms.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used herein, unless stated explicitly, performing a step “in response to A” does not indicate that the step is performed immediately after “A” occurs and one or more intervening steps may be included.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G), the sixth generation (6G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), an NR NB (also referred to as a gNB), a Remote Radio Unit (RRU), a radio header (RH), a remote radio head (RRH), a relay, an Integrated Access and Backhaul (IAB) node, a low power node such as a femto, a pico, a non-terrestrial network (NTN) or non-ground network device such as a satellite network device, a low earth orbit (LEO) satellite and a geosynchronous earth orbit (GEO) satellite, an aircraft network device, and so forth, depending on the applied terminology and technology. In some example embodiments, radio access network (RAN) split architecture comprises a Centralized Unit (CU) and a Distributed Unit (DU) at an IAB donor node. An IAB node comprises a Mobile Terminal (IAB-MT) part that behaves like a UE toward the parent node, and a DU part of an IAB node behaves like a base station toward the next-hop IAB node.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to a Mobile Termination (MT) part of an IAB node (e.g., a relay node). In the following description, the terms “terminal device”, “communication device”, “terminal”, “user equipment” and “UE” may be used interchangeably.

As used herein, the term “resource,” “transmission resource,” “resource block,” “physical resource block” (PRB), “uplink resource,” or “downlink resource” may refer to any resource for performing a communication, for example, a communication between a terminal device and a network device, such as a resource in time domain, a resource in frequency domain, a resource in space domain, a resource in code domain, or any other combination of the time, frequency, space and/or code domain resource enabling a communication, and the like. In the following, unless explicitly stated, a resource in both frequency domain and time domain will be used as an example of a transmission resource for describing some example embodiments of the present disclosure. It is noted that example embodiments of the present disclosure are equally applicable to other resources in other domains. The term “model” used herein may refer to a data driven algorithm that applies artificial intelligence (AI)/machine learning (ML) techniques to generate a set of outputs based on a set of inputs. The term “beam” used herein may refer to an index of channel sate information reference signal (CSI-RS) or an index of a synchronization signal physical broadcast channel (PBCH) signal (SSB). The term “continual learning” used herein may refer to an ability of a model to learn continually from a stream of data. The term “Reinforcement Learning (RL)” used herein may refer to a type of machine learning technique that enables an agent to learn in an interactive environment by trial and error using feedback from its own actions and experiences. The reinforcement learning may be a special type of continual learning. In general, a RL agent is able to perceive and interpret its environment, take actions and learn through trial and error. The term “reinforcement learning exploration” used herein may refer to an essential component of reinforcement learning algorithms, where agents need to learn how to predict and control unknown and often stochastic environments. The term “reinforcement learning model” used herein may refer to any model that will learn by trail and error. A “reinforcement learning model” may be deep neural network based model or any statistical model.

As mentioned above, machine learning, such as reinforcement learning or deep reinforcement learning may be used as a decision-making tool to address complex problems which are highly dimensional given the number of control parameters to be optimized and stringent timing constraints. Reinforcement learning (RL) is a field of machine learning where the agent learns by trial and error a policy to maximize the given performance objective. The agent selects an action based on the current state of the environment. The action influences on the environment and leads to a new state and reward (goodness of the action in given state). Objective of the agent is to learn which actions with given state leads to highest cumulative future reward.

Purpose of the trial-and-error is to gain knowledge about what is working and what isn't. This includes a concept of exploration vs exploitation where exploration refers to select random actions, while exploitation means that the agent exploits the learned policy i.e., the information received so far. In practice RL algorithms must balance between the exploration and exploitation. Typically, before converging to a good policy, the RL algorithms start by exploring with high probability and decreases the probability of exploration as the agent starts to learn. Agent is typically considered to be learning, when the received rewards increase over time and stabilize to a certain level.

Further, it is hard to maintain a good system performance during the process of training a RL based model. This is mainly due to the importance of exploration step (occasional random actions) which will have direct impact on the system performance due to taking less optimal actions while searching for optimal ones. Initially, the RL model will have poor performance and using the poor model directly for taking decisions will significantly have an impact on the system performance. Taken the RL QoS model-based beam management (BM) as an example, such RL model will be trained to take actions (selecting best beam) in order to maximize the QoS, and so, for each taken action the model receives QoS level as reward and the target is to maximize this reward through selecting the best beams. Given that said, it needs the RL model to be trained with QoS levels which matches the QoS levels when real user data/traffic is transmitted over the selected beam. For that, it needs actual real data/traffic to be transferred using different actions (different beams) and then evaluate the different achieved QoS levels which are reward per action. Using dummy synthetic data may/may not work in this case as the achieved QoS levels using the dummy data may be different than QoS using real traffic. In addition to that, using dummy data for training will waste radio resources for transmitting data that will be used only for RL model training. The term “dummy” here may refer to a data that does not reflect the real user data nature and distribution. However, using the user actual data/traffic within exploration step will end up with unhappy user due to possible drop in QoS levels when taking suboptimal actions. Therefore, solutions on how to use real data/traffic for training and evaluating the RL model with minimal impact on the actual user/system QoS and how to optimally utilize the available radio resources during the RL training process are needed.

According to embodiments of the present disclosure, it utilizes side links capabilities for enabling real data/traffic exchange for RL explorative training step. In this way, it enables a radio system performance friendly RL learning training operation from one side and will utilize the available radio air resources on the other side. In general, a network device trains a RL model, then the network device gives the RL model an input and asks it for action/output, i.e., beam identity (ID). In this case, the network device doesn't know if this beam ID is the best so far or action from the RL model. By allowing the RL model to take several actions for the same input, and then by sending the same main user data over those beams, it increases the chance that the data will be received at the network device by an exploitive beam even it may not come from the main user terminal and at the same time other exploration beams are under test. Further, it can reduce the training time of the RL model with minimum impact on the system.

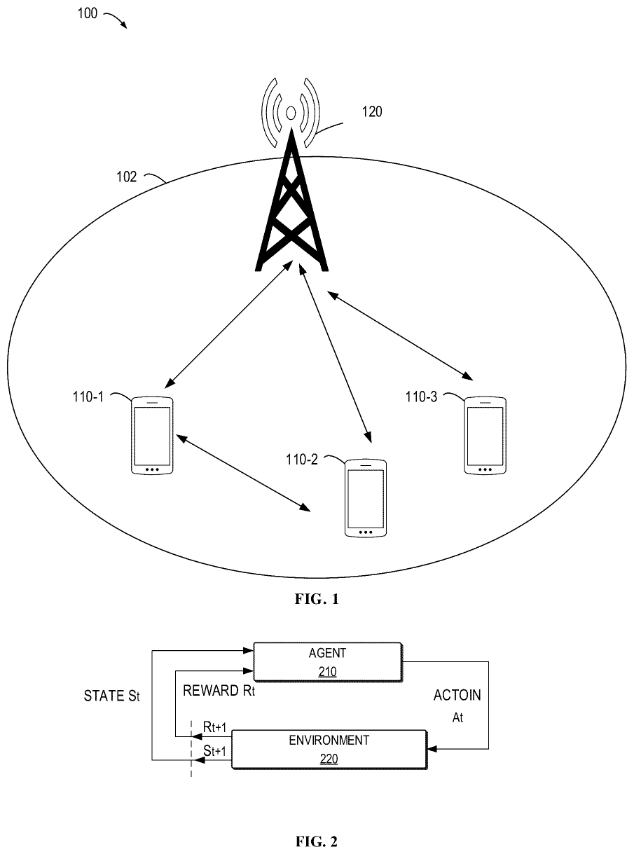

FIG. 1 illustrates an example communication environment 100 in which example embodiments of the present disclosure can be implemented. The communication environment 100 includes a device 110-1, a device 110-2, a device 110-3 (collectively referred to as device 110) and a device 120 which can communicate with each other. The device 110-1 and the device 110-2 can be close by users with side link capabilities.

In the following, for the purpose of illustration, some example embodiments are described with the devices 110-1, 110-2 and 110-3 operating as terminal devices and the device 120 operating as a network device. However, in some example embodiments, operations described in connection with a terminal device may be implemented at a network device or other device, and operations described in connection with a network device may be implemented at a terminal device or other device.

In some example embodiments, if the device 110 is a terminal device and the device 120 is a network device, a link from the device 120 to the device 110 is referred to as a downlink (DL), and a link from the device 110 to the device 120 is referred to as an uplink (UL). In DL, the device 120 is a transmitting (TX) device (or a transmitter) and the device 110 is a receiving (RX) device (or a receiver). In UL, the device 110 is a TX device (or a transmitter) and the device 120 is a RX device (or a receiver). A link among the devices 110-1, 110-2 and 110-3 is referred to as a sidelink (SL).

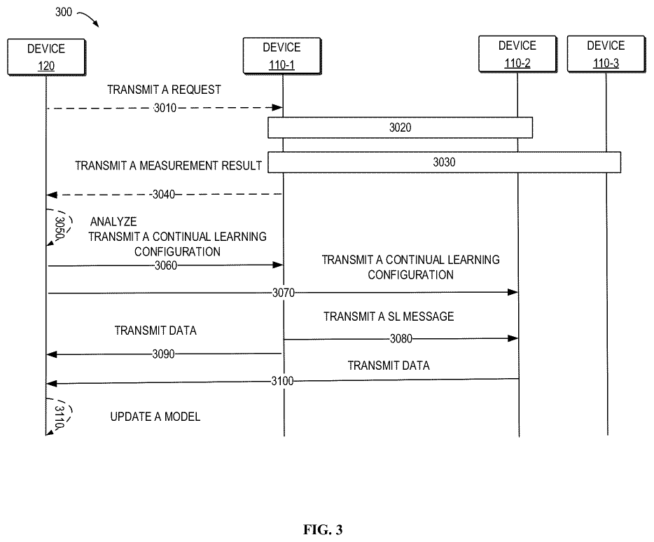

The AI/ML techniques can be applied in the communication environment 100. The AI/ML techniques can be adopted in a plurality of scenarios. For example, the set of use cases of AI/ML techniques may include channel state information (CSI) feedback enhancement, a beam management (BM), and a positioning accuracy enhancement. FIG. 2 shows a schematic diagram of agent-environment interaction for reinforcement learning, which can be applied in the communication environment 100. Taken BM as an example, which is a key use case that is studied under AI/ML topic where supervised learning approaches are explored to reduce the measurement overhead of BM, as shown in FIG. 2, RL based approaches are to be studied for BM where a RL agent 210 selects the beam to maximize throughput or minimize latency (QoS). Since the strongest beam does not always correlate to the best QoS in every situation/configuration, e.g., frequency range 2 (FR2) analog beam forming, RL agent 210 is trained to select the DL beam to improve QoS. Here, RL agent 210 needs to explore the environment 220 by applying different DL beams and observing the reward which can be throughput or latency, depending on the QoS class of the UE.

Communications in the communication environment 100 may be implemented according to any proper communication protocol(s), comprising, but not limited to, cellular communication protocols of the first generation (1G), the second generation (2G), the third generation (3G), the fourth generation (4G), the fifth generation (5G), the sixth generation (6G), and the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

Example embodiments of the present disclosure will be described in detail below with reference to the accompanying drawings.

Reference is now made to FIG. 3, which illustrates a signaling flow 300 for RL on BM according to some example embodiments of the present disclosure. For the purposes of discussion, the signaling flow 300 will be discussed with reference to FIG. 1, for example, by using the device 110-1, the device 110-2, the device 110-3 and the device 120.

The device 120 may transmit (3010) a request for a sidelink measurement to the device 110-1. In other words, the device 110-1 may receive the request for the sidelink measurement. In some example embodiments, the request may indicate a list of devices to be measured. The list of devices may include one or more idle terminal devices that are candidates to support RL exploration. That is, the one or more idle terminal devices can be candidates to operate lightweight test mode. The term “idle terminal device” used herein may refer to a terminal device that does not have data or information to transmit. In some example embodiments, the sidelink measurement may include a reference signal received power (RSRP) measurement. Alternatively, the sidelink measurement may include a positioning measurement. It is noted that the sidelink measurement may include any proper types of measurement.

After receiving the request for the sidelink measurement, the device 110-1 may perform the sidelink measurement with at least one neighbor device. For example, the device 110-1 may perform (3020) the sidelink measurement with the device 110-2. The device 110-1 may also perform (3030) the sidelink measurement with the device 110-3. For example, the device 110-1 may start performing the sidelink measurement to detect its neighbor devices (for example, the devices 110-2 and/or 110-3) upon the reception of the request for the sidelink measurement. By way of example, the device 110-1 may measurement the RSRP from the device 110-2 and/or 110-3.

The device 110-1 may transmit (3040) a result of the sidelink measurement to the device 120. In other words, the device 120 may receive the result of the sidelink measurement from the device 110-1. For example, the device 110-1 may report the sidelink measurements of the device 110-2 and the device 110-3 to the device 120. By way of example, if the sidelink measurement is the RSRP measurement, the measured (3020, 3030) RSRP of the device 110-2 and the device 110-3 may be reported to the device 120.

The device 120 may determine a target device from the at least one neighbor based on the result of the sidelink measurement received from the device 110-1. For example, the device 120 may analyze (3050) the received result of the sidelink measurement. In this case, the device 120 may determine a target device from the at least one neighbor device by analyzing the received result of the sidelink measurement. By way of example, the device 120 may start grouping devices into pairs for RL explorative cooperation operation based on the result of the sidelink measurement. As an example, if the RSRP of the device 110-2 is higher than the RSRP of the device 110-3, the device 120 may regard the device 110-1 and the device 110-2 as a pair for RL explorative cooperation operation. In other words, the device 120 may assign the device 110-2 to the lightweight test mode.

In some example embodiments, the device 120 may obtain information related to data to be transmitted by the device 110-1. Alternatively, or in addition, the device 120 may obtain first terminal sidelink information related to the device 110-2.

The device 120 may select a beam (referred to as “first beam” hereinafter) by a reinforcement learning model at the device 120. The first beam can be selected as the best beam for a transmission of the device 110-1 according to the reinforcement learning model (i.e., the latest RL trained model). The device 120 may select another beam (referred to as “second beam” hereinafter) for an exploration of the reinforcement learning model. The second beam may not be the best beam according to the reinforcement learning model but rather selected for the transmission as part of the RL exploration process. Since the transmission over the device 110-2 is only for RL purpose, at worst transmission with low QoS may be beneficial for RL update and at best the QoS of the transmission may be high which allows to not only update the RL accordingly but also to make use of the transmitted data at gNB side. In this case, useful data can be transmitted in the uplink through two different sources.

In some example embodiments, the device 120 may select a plurality of second beams for the exploration of the reinforcement learning model. For example, the device 120 may determine a plurality of neighbor devices of the device 110-1, and each of the plurality of neighbor devices corresponds to one of the plurality of second beams.

The device 120 transmits (3060) a continual learning configuration to the device 110-1. In other words, the device 110-1 receives the continual learning configuration from the device 120. In some example embodiments, the continual learning configuration may indicate a neighbor device that is selected from the at least one neighbor device. For example, if the device 120 selects the device 110-2, the continual learning configuration may include an identity of the device 110-2. The identity may be any suitable types of identities. Alternatively, or in addition, the continual learning configuration may indicate the first beam. For example, the continual learning configuration may include an identity (also referred to as “first identity”) or an index of the first beam. The continual learning configuration may also indicate the second beam. For example, the continual learning configuration may include an identity (also referred to as “second identity”) or an index of the second beam. In some other example embodiments, the continual learning configuration may further indicate a data type of the data transmitted to the device 120 based on the reinforcement learning model. For example, the continual learning configuration may include a traffic type of the data. As mentioned above, the plurality of plurality of neighbor devices and the corresponding plurality of second beams may be selected for the exploration of the reinforcement learning model. In this case, the continual learning configuration may indicate identities of the plurality of plurality of neighbor devices and beam identities of the plurality of second beams.

The device 120 transmits (3070) the continual learning configuration to at least one neighbor device (for example, the device 110-2). In other words, the device 110-2 receives the continual learning configuration from the device 120. As mentioned above, the continual learning configuration may indicate at least one of: the neighbor device (for example, the device 110-2), the first identity of the first beam, or the second identity of the second beam.

The device 110-1 transmits (3080) a sidelink message to the device 110-2. In other words, the device 110-2 receives the sidelink message from the device 110-1. For example, the device 110-2 is indicated in the continual learning configuration. The sidelink message includes data that is to be transmitted to the device 120. The sidelink message may also include the second identity of the second beam. As mentioned above, the plurality of plurality of neighbor devices and the corresponding plurality of second beams may be selected for the exploration of the reinforcement learning model. In this case, the device 110-1 may also transmit the sidelink message to the plurality of neighbor devices.

The device 110-1 transmits (3090) the data to the device 120 via the first beam. In other words, the device 120 receives the data from the device 110-1 via the first beam. The device 110-2 transmits (3100) the data to the device 120 via the second beam. In other words, the device 120 also receives the data from the device 110-2. As mentioned above, the plurality of neighbor devices and the corresponding plurality of second beams may be selected for the exploration of the reinforcement learning model. In this case, the plurality of neighbor devices may transmit the data to the device 120 via their corresponding beams. In other words, the device 120 can receive the data from the plurality of neighbor devices using different beams.

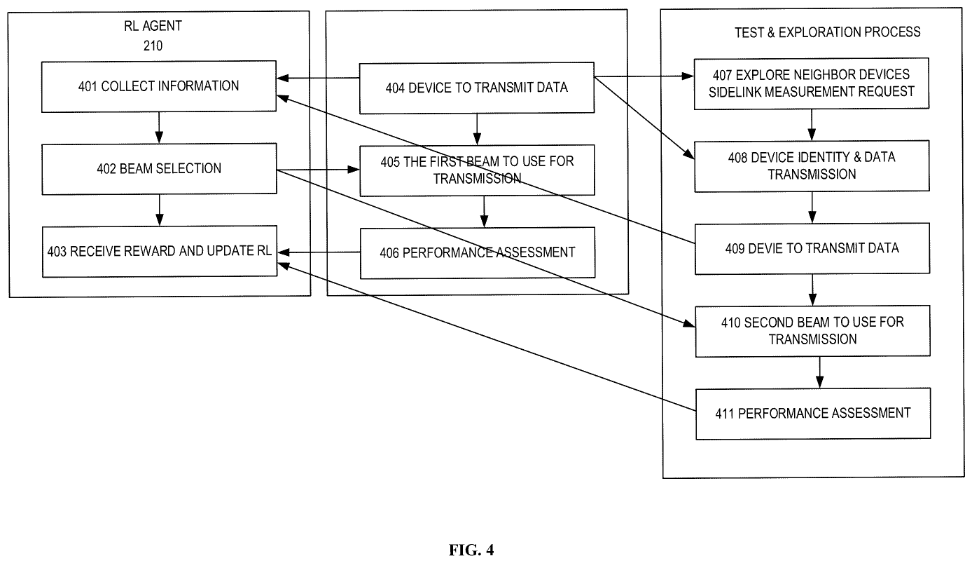

The device 120 may update (3110) update the reinforcement learning model based on the data received (3090) from the device 110-1 and the data received (3100) from the device 110-2. FIG. 4 illustrates the different steps of example embodiments with regards to the RL agent 210 which may be located at the device 120 or any other entity of the network as well as differentiating the steps related to conventional data transmission and the novel steps dedicated to the lightweight test mode with new transmissions targeted to enhance RL exploration. As mentioned above, the plurality of neighbor devices and the corresponding plurality of second beams may be selected for the exploration of the reinforcement learning model. In this case, the reinforcement learning model can be updated based on the data received from the plurality of neighbor devices.

The RL agent 210 may collect (401) information on the different devices where the device 110-1 refers to an active UE with real data transmission whereas other UEs (for example, the device 110-2) are idles and are then can be candidate to operate in lightweight test mode. In step 401, the RL agent 210 may collect information related to data to be transmitted in the UL by the device 110-1 as well sidelink information on neighboring candidate devices. It is then up to the RL agent 210 to select the beams for the transmissions of the devices 110-1 and 110-2, at step 402. In this case, the device 110-1 is allocated the exploitive beam which refers to the identified best beam with the ongoing RL model. Whereas the device 110-2 is allocated with explorative beam (as the bad transmission will not really degrade real transmission).

At step 403, the RL agent 210 may receive the reward information with regards to both the transmissions of the devices 110-1 and 110-2 and update its RL model accordingly. In some solutions, the decision related to the transmission of the device 110-1 is realized at step 404 and following a decision on the beam identified as best according to the latest RL trained model. In this example, the device 110-2 is allocated to the device 110-1 as exploitive Beam id at step 405. The performance of this transmission is thereafter assessed (e.g. throughput/QoS KPI) and shared with RL agent 210 at step 406. Embodiments of the present disclosure reply on the test & exploration process which is based on sidelink and the usage of the lightweight test mode. In fact, to enable this RL exploration solution, it is first needed to explore neighboring devices through dedicated sidelink measurements (standardized measurements) at step 407. The device 110-2 is thereafter identified as the candidate device to operate in lightweight test mode: meaning it is close enough to the device 110-1 and can help within the RL exploration process regardless of possible transmission failures impacts. Data is then shared by the device 110-1 to the device 110-2 through sidelink at step 408 and thereafter the device 110-2 can perform (409) the transmission of this data using (410) the beam id selected by the RL agent 210. The performance of the device 110-2 using the second beam is assessed and the information is shared with the RL agent 210 at step 411.

Embodiments of the present disclosure propose signaling enhancement to initiate and enable lightweight test mode for RL exploration enhancement purpose. Utilizing side link for reusing real data for RL explorative training step may allow to use real data and so training RL model to learn real targets. Beside RL purposes, relaying same data of a device by another device can have a good performance impact on QoS of the device. Moreover, this can compensate the impact of RL training on the radio air resources that are used for training purposes.

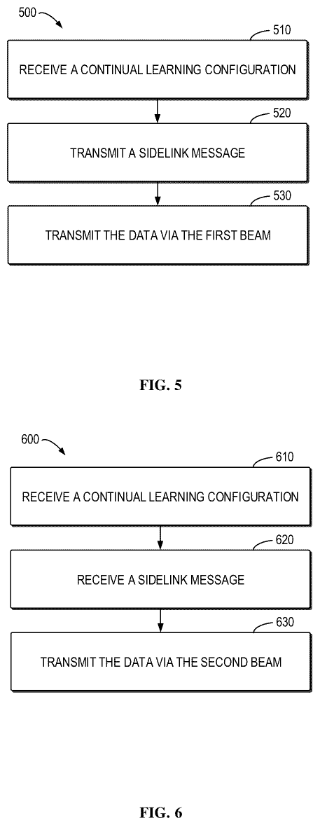

FIG. 5 shows a flowchart of an example method 500 implemented at a device in accordance with some example embodiments of the present disclosure. For the purpose of discussion, the method 500 will be described from the perspective of the device 110-1 in FIG. 1.

At block 510, the device 110-1 receives, from a network device, a continual learning configuration indicating at least one of: a neighbor apparatus, a first identity of a first beam, or a second identity of a second beam. In some example embodiments, the first beam is obtained based on a reinforcement learning model at the network device, and wherein the second beam is selected for a reinforcement learning exploration of the reinforcement learning model. In some example embodiments, the configuration further indicates a data type of the data transmitted to the network device based on the reinforcement learning model. In some example embodiments, at least one of the first beam or the second beam is for an exploration of the reinforcement learning model.

At block 520, the device 110-1 transmits, to the neighbor apparatus, a sidelink message comprising data and the second identity of the second beam.

At block 530, the device 110-1 transmits, to the network device, the data via the first beam. In some example embodiments, the method 500 further comprises: receiving, from the network device, a request for a sidelink measurement; performing the sidelink measurement with at least one neighbor apparatus; and transmitting, to the network device, a result of the sidelink measurement regarding the at least one neighbor apparatus.

In some example embodiments, the apparatus comprises a terminal device, and the neighbor apparatus comprises another terminal device.

FIG. 6 shows a flowchart of an example method 600 implemented at a device in accordance with some example embodiments of the present disclosure. For the purpose of discussion, the method 600 will be described from the perspective of the device 110-2 in FIG. 1.

At block 610, the device 110-2 receives, from a network device, a continual learning configuration indicating at least one of: the apparatus, a first identity of a first beam, or a second identity of a second beam. In some example embodiments, the first beam is obtained based on a reinforcement learning model at the network device, and wherein the second beam is selected for an exploration of the reinforcement learning model. In some example embodiments, at least one of the first beam or the second beam is for an exploration of the reinforcement learning model.

At block 620, the device 110-2 receives, from a neighbor apparatus, a sidelink message comprising data and the second identity of the second beam.

At block 630, the device 110-2 transmits, to the network device, the data via the second beam.

In some example embodiments, the configuration further indicates a data type of the data transmitted to the network device based on the reinforcement learning model. In some example embodiments, the apparatus comprises a terminal device, and the neighbor apparatus comprises another terminal device.

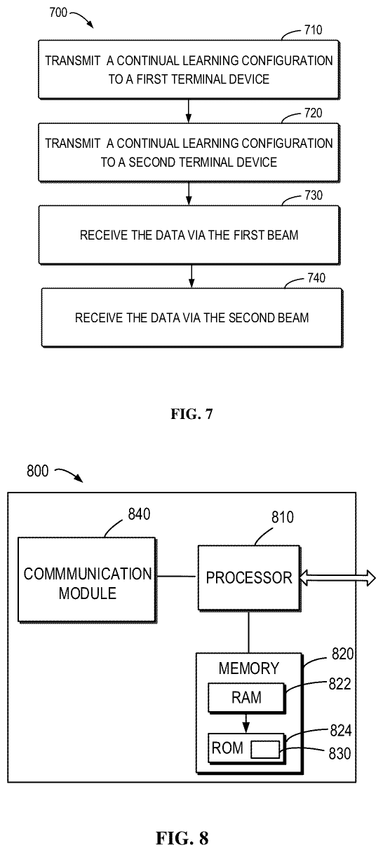

FIG. 7 shows a flowchart of an example method 700 implemented at a device in accordance with some example embodiments of the present disclosure. For the purpose of discussion, the method 700 will be described from the perspective of the device 120 in FIG. 1.

At block 710, the device 120 transmits, to a first terminal device, a continual learning configuration indicating at least one of a second terminal device, a first identity of a first beam, or a second identity of a second beam. At block 720, the device 120 transmits the continual learning configuration to a second terminal device.

At block 730, the device 120 receives, from the first terminal device, data via the first beam. At block 740, the device 120 receives, from the second terminal device, the data via the second beam.

In some example embodiments, the method 700 further comprises: transmitting, to the first terminal device, a request for a sidelink measurement; receiving, from the first terminal device, a result of the sidelink measurement regarding at least one neighbor terminal device of the first terminal device. determining the second terminal device from the at least one neighbor terminal device based on the result of the sidelink measurement received from the first terminal device.

In some example embodiments, the method 700 further comprises: obtaining information related to the data to be transmitted by the first terminal device; obtaining first terminal sidelink information related to the second terminal device.

In some example embodiments, the method 700 further comprises: selecting, by a reinforcement learning model at the apparatus, the first beam; and selecting, by the reinforcement learning model at the apparatus, the second beam for an exploration of the reinforcement learning model.

In some example embodiments, the method 700 further comprises: updating a reinforcement learning model at the apparatus based on the data received from the first terminal device and the data received from the second terminal device.

In some example embodiments, the apparatus is a network device.

In some example embodiments, a first apparatus capable of performing any of the method 500 (for example, the device 110-1 in FIG. 1) may comprise means for performing the respective operations of the method 500. The means may be implemented in any suitable form. For example, the means may be implemented in a circuitry or software module. The first apparatus may be implemented as or included in the device 110-1 in FIG. 1.

In some example embodiments, the first apparatus comprises means for receiving, from a network device, a continual learning configuration indicating at least one of: a neighbor apparatus, a first identity of a first beam, or a second identity of a second beam; means for transmitting, to the neighbor apparatus, a sidelink message comprising data and the second identity of the second beam; and means for transmitting, to the network device, the data via the first beam.

In some example embodiments, the first beam is obtained based on a reinforcement learning model reinforcement learning model at the network device, and wherein the second beam is selected for an exploration of the model.

In some example embodiments, at least one of the first beam or the second beam is for an exploration of the reinforcement learning model.

In some example embodiments, the configuration further indicates a data type of the data transmitted to the network device based on the reinforcement learning model.

In some example embodiments, the first apparatus further comprises: means for receiving, from the network device, a request for a sidelink measurement; means for performing the sidelink measurement with at least one neighbor apparatus; and means for transmitting, to the network device, a result of the sidelink measurement regarding the at least one neighbor apparatus.

In some example embodiments, the apparatus comprises a terminal device, and the neighbor apparatus comprises another terminal device.

In some example embodiments, the first apparatus further comprises means for performing other operations in some example embodiments of the method 500 or the device 110-1. In some example embodiments, the means comprises at least one processor; and at least one memory storing instructions that, when executed by the at least one processor, cause the performance of the first apparatus.

In some example embodiments, a second apparatus capable of performing any of the method 600 (for example, the device 110-2 in FIG. 1) may comprise means for performing the respective operations of the method 600. The means may be implemented in any suitable form. For example, the means may be implemented in a circuitry or software module. The second apparatus may be implemented as or included in the device 110-2 in FIG. 1.

In some example embodiments, the second apparatus comprises means for receiving, from a network device, a continual learning configuration indicating at least one of: the apparatus, a first identity of a first beam, or a second identity of a second beam; means for receiving, from a neighbor apparatus, a sidelink message comprising data and the second identity of the second beam; and means for transmitting, to the network device, the data via the second beam.

In some example embodiments, the first beam is obtained based on a reinforcement learning model at the network device, and wherein the second beam is selected for an exploration of the reinforcement learning model.

In some example embodiments, at least one of the first beam or the second beam is for an exploration of the reinforcement learning model.

In some example embodiments, the configuration further indicates a data type of the data transmitted to the network device based on the reinforcement learning model.

In some example embodiments, the apparatus comprises a terminal device, and the neighbor apparatus comprises another terminal device.

In some example embodiments, the second apparatus further comprises means for performing other operations in some example embodiments of the method 600 or the device 110-2. In some example embodiments, the means comprises at least one processor; and at least one memory storing instructions that, when executed by the at least one processor, cause the performance of the second apparatus.

In some example embodiments, a third apparatus capable of performing any of the method 700 (for example, the device 120 in FIG. 1) may comprise means for performing the respective operations of the method 700. The means may be implemented in any suitable form. For example, the means may be implemented in a circuitry or software module. The third apparatus may be implemented as or included in the device 120 in FIG. 1.

In some example embodiments, the third apparatus comprises means for transmitting, to a first terminal device, a continual learning configuration indicating at least one of a second terminal device, a first identity of a first beam, or a second identity of a second beam; means for transmitting the continual learning configuration to a second terminal device; means for receiving, from the first terminal device, data via the first beam; and means for receiving, from the second terminal device, the data via the second beam.

In some example embodiments, the third apparatus further comprises: means for transmitting, to the first terminal device, a request for a sidelink measurement; means for receiving, from the first terminal device, a result of the sidelink measurement regarding at least one neighbor terminal device of the first terminal device. means for determining the second terminal device from the at least one neighbor terminal device based on the result of the sidelink measurement received from the first terminal device.

In some example embodiments, the third apparatus further comprises: means for obtaining information related to the data to be transmitted by the first terminal device; means for obtaining first terminal sidelink information related to the second terminal device.

In some example embodiments, the third apparatus further comprises: means for selecting, by a reinforcement learning model at the apparatus, the first beam; and means for selecting, by the reinforcement learning model at the apparatus, the second beam for an exploration of the reinforcement learning model.

In some example embodiments, the third apparatus further comprises: means for updating a reinforcement learning model at the apparatus based on the data received from the first terminal device and the data received from the second terminal device.

In some example embodiments, the apparatus is a network device.

In some example embodiments, the third apparatus further comprises means for performing other operations in some example embodiments of the method 700 or the device 120. In some example embodiments, the means comprises at least one processor; and at least one memory storing instructions that, when executed by the at least one processor, cause the performance of the third apparatus.

FIG. 8 is a simplified block diagram of a device 800 that is suitable for implementing example embodiments of the present disclosure. The device 800 may be provided to implement a communication device, for example, the device 110-1, the device 110-2 or the device 120 as shown in FIG. 1. As shown, the device 800 includes one or more processors 810, one or more memories 820 coupled to the processor 810, and one or more communication modules 840 coupled to the processor 810.

The communication module 840 is for bidirectional communications. The communication module 840 has one or more communication interfaces to facilitate communication with one or more other modules or devices. The communication interfaces may represent any interface that is necessary for communication with other network elements. In some example embodiments, the communication module 840 may include at least one antenna.

The processor 810 may be of any type suitable to the local technical network and may include one or more of the following: general purpose computers, special purpose computers, microprocessors, digital signal processors (DSPs) and processors based on multicore processor architecture, as non-limiting examples. The device 800 may have multiple processors, such as an application specific integrated circuit chip that is slaved in time to a clock which synchronizes the main processor.

The memory 820 may include one or more non-volatile memories and one or more volatile memories. Examples of the non-volatile memories include, but are not limited to, a Read Only Memory (ROM) 824, an electrically programmable read only memory (EPROM), a flash memory, a hard disk, a compact disc (CD), a digital video disk (DVD), an optical disk, a laser disk, and other magnetic storage and/or optical storage. Examples of the volatile memories include, but are not limited to, a random access memory (RAM) 822 and other volatile memories that will not last in the power-down duration.

A computer program 830 includes computer executable instructions that are executed by the associated processor 810. The instructions of the program 830 may include instructions for performing operations/acts of some example embodiments of the present disclosure. The program 830 may be stored in the memory, e.g., the ROM 824. The processor 810 may perform any suitable actions and processing by loading the program 830 into the RAM 822.

The example embodiments of the present disclosure may be implemented by means of the program 830 so that the device 800 may perform any process of the disclosure as discussed with reference to FIG. 2 to FIG. 7. The example embodiments of the present disclosure may also be implemented by hardware or by a combination of software and hardware.

In some example embodiments, the program 830 may be tangibly contained in a computer readable medium which may be included in the device 800 (such as in the memory 820) or other storage devices that are accessible by the device 800. The device 800 may load the program 830 from the computer readable medium to the RAM 822 for execution. In some example embodiments, the computer readable medium may include any types of non-transitory storage medium, such as ROM, EPROM, a flash memory, a hard disk, CD, DVD, and the like. The term “non-transitory,” as used herein, is a limitation of the medium itself (i.e., tangible, not a signal) as opposed to a limitation on data storage persistency (e.g., RAM vs. ROM).

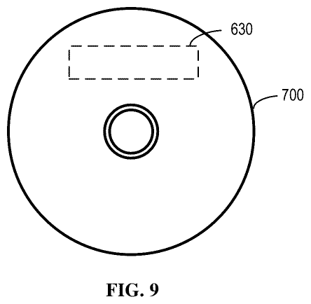

FIG. 9 shows an example of the computer readable medium 900 which may be in form of CD, DVD or other optical storage disk. The computer readable medium 900 has the program 830 stored thereon.

Generally, various embodiments of the present disclosure may be implemented in hardware or special purpose circuits, software, logic or any combination thereof. Some aspects may be implemented in hardware, and other aspects may be implemented in firmware or software which may be executed by a controller, microprocessor or other computing device. Although various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

Some example embodiments of the present disclosure also provide at least one computer program product tangibly stored on a computer readable medium, such as a non-transitory computer readable medium. The computer program product includes computer-executable instructions, such as those included in program modules, being executed in a device on a target physical or virtual processor, to carry out any of the methods as described above. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. The program code may be provided to a processor or controller of a general purpose computer, special purpose computer, or other programmable data processing apparatus, such that the program code, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program code or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, although operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, although several specific implementation details are contained in the above discussions, these should not be construed as limitations on the scope of the present disclosure, but rather as descriptions of features that may be specific to particular embodiments. Unless explicitly stated, certain features that are described in the context of separate embodiments may also be implemented in combination in a single embodiment. Conversely, unless explicitly stated, various features that are described in the context of a single embodiment may also be implemented in a plurality of embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1.-31. (canceled)

32. An apparatus comprising:
at least one processor; and
at least one memory storing instructions that, when executed by the at least one processor, cause the apparatus to:
receive, from a network device, a request for a sidelink measurement, the request indicates a plurality of devices to be measured, wherein plurality of devices are idle terminal devices that are candidates to support reinforcement learning exploration to operate lightweight test mode;
based on the request, perform sidelink measurements the plurality of devices, wherein the sidelink measurements include a reference signal received power (RSRP) measurement;
based on the RSRP of a second device being a highest of the plurality devices, pair the apparatus with the second device for reinforcement learning exploration operation;
receive continual learning information indicating the following: that a first beam is assigned to the apparatus based on the first beam being capable of maximizing throughput and minimizing latency compared to other beams according to a reinforcement learning model, and that a second beam is assigned to the second device for exploration of the reinforcement learning model, the second beam being utilized by the second device to transmit data;
transmit, to the second device, a sidelink message comprising the data and an identity of the second beam to enable the second device to transmit the data to the network device via the second beam; and
cause an update to the reinforcement learning model by transmitting, to the network device, the data via the first beam.

33. The apparatus of claim 32, wherein an idle terminal device is a terminal device that does not have data or information to transmit.

34. The apparatus of claim 33, wherein the first beam and the second beam are an index of channel sate information reference signal (CSI-RS).

35. The apparatus of claim 33, wherein the first beam and the second beam are index of a synchronization signal physical broadcast channel (PBCH) signal (SSB).

36. The apparatus of claim 35, wherein the continual learning configuration further indicates a data type of the data transmitted to the network device based on the reinforcement learning model at the network device.

37. The apparatus of claim 36, wherein the continual learning configuration further indicates a traffic type of the data.

38. The apparatus of claim 37, wherein the apparatus comprises a terminal device, and the second device comprises another terminal device.

39. A system comprising:
an apparatus:
at least one processor; and
at least one memory storing instructions that, when executed by the at least one processor, cause the apparatus to:
receive, from a network device, a request for a sidelink measurement, the request indicates a plurality of devices to be measured, wherein plurality of devices are idle terminal devices that are candidates to support reinforcement learning exploration to operate lightweight test mode;
based on the request, perform sidelink measurements the plurality of devices, wherein the sidelink measurements include a reference signal received power (RSRP) measurement;
based on the RSRP of a second device being a highest of the plurality devices, pair the apparatus with the second device for reinforcement learning exploration operation;
receive continual learning information indicating the following: that a first beam is assigned to the apparatus based on the first beam being capable of maximizing throughput and minimizing latency compared to other beams according to a reinforcement learning model, and that a second beam is assigned to the second device for exploration of the reinforcement learning model, the second beam being utilized by the second device to transmit data;
transmit, to the second device, a sidelink message comprising the data and an identity of the second beam to enable the second device to transmit the data to the network device via the second beam; and
cause an update to the reinforcement learning model by transmitting, to the network device, the data via the first beam.

40. The system of claim 39, wherein an idle terminal device is a terminal device that does not have data or information to transmit.

41. The system of claim 40, wherein the first beam and the second beam are an index of channel sate information reference signal (CSI-RS).

42. The system of claim 41, wherein the first beam and the second beam are index of a synchronization signal physical broadcast channel (PBCH) signal (SSB).

43. The system of claim 42, wherein the continual learning configuration further indicates a data type of the data transmitted to the network device based on the reinforcement learning model at the network device.

44. The system of claim 43, wherein the continual learning configuration further indicates a traffic type of the data.

45. The system of claim 45, wherein the apparatus comprises a terminal device, and the second device comprises another terminal device.

46. A method comprising:
receiving, by an apparatus from a network device, a request for a sidelink measurement, the request indicates a plurality of devices to be measured, wherein plurality of devices are idle terminal devices that are candidates to support reinforcement learning exploration to operate lightweight test mode;
based on the request, performing sidelink measurements the plurality of devices, wherein the sidelink measurements include a reference signal received power (RSRP) measurement;
based on the RSRP of a second device being a highest of the plurality devices, pairing the apparatus with the second device for reinforcement learning exploration operation;
receiving continual learning information indicating the following: that a first beam is assigned to the apparatus based on the first beam being capable of maximizing throughput and minimizing latency compared to other beams according to a reinforcement learning model, and that a second beam is assigned to the second device for exploration of the reinforcement learning model, the second beam being utilized by the second device to transmit data;
transmitting, to the second device, a sidelink message comprising the data and an identity of the second beam to enable the second device to transmit the data to the network device via the second beam; and
causing an update to the reinforcement learning model by transmitting, to the network device, the data via the first beam.

47. The method of claim 46, wherein an idle terminal device is a terminal device that does not have data or information to transmit.

48. The method of claim 47, wherein the first beam and the second beam are an index of channel sate information reference signal (CSI-RS).

49. The method of claim 47, wherein the first beam and the second beam are index of a synchronization signal physical broadcast channel (PBCH) signal (SSB).

50. The method of claim 49, wherein the continual learning configuration further indicates a data type of the data transmitted to the network device based on the reinforcement learning model at the network device.

51. The method of claim 50, wherein the continual learning configuration further indicates a traffic type of the data.
